(19) United States
(12) Patent Application Publication
(10) Pub. No.: US 2009/0294340 A1
(43) Pub. Date: Dec. 3, 2009

(54) PRESSURE FILTER FOR PROCESSING A LARGE VOLUME OF FLUID WITH AUTOMATIC BACKWASHING BY LINEAR AND ROTATION OF THE BACKWASH TUBE

(76) Inventor: Gene Hirs, Waterford, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/502,280

(22) Filed: Jul. 14, 2009

Related U.S. Application Data
(63) Continuation-in-part of application No. 12/043,648, filed on Mar. 6, 2008.

(51) Int. Cl. B01D 29/62

(52) U.S. Cl. 210/108

(57) ABSTRACT

A pressure filter for processing a large volume of liquid containing multiple internal vertical cartridges that are backwashed through a central backwash tube that travels axially and rotates during backwashing.

### CROSS-REFERENCE TO RELATED APPLICATIONS

This application is a continuation-in-part of U.S. patent application Ser. No. 12/043,648 filed Mar. 6, 2008.

### FIELD OF THE INVENTION

A pressure filter for processing a large volume of liquid containing multiple internal vertical cartridges that are backwashed through a central backwash tube that travels axially and rotates during backwashing.

### BACKGROUND OF THE INVENTION

Pressure liquid filters containing cartridges or tubes with a permanent mesh covering filter media are commonly used but have limitations. Cartridge filters generally are removed manually and discarded after being used. Tube filters with wire mesh sock cover can be backwashed by compressed air shocking of the liquid and backflow occurs. This does not work effectively if longer tubes are used since the backwash liquid will escape to the lower end of the tube leaving the upper portion uncleaned.

### SUMMARY OF THE INVENTION

The present invention discloses a pressure vessel with cartridges that are 72 inches long with a monofilament polymeric filter mesh covering the 6″ diameter of the outside of the cartridge. To backwash this in a stationary tube would require 78 nozzles and 156 GPM per cartridge. With a filter with 50 cartridges would require 3900 nozzles and require 7800 GPM backwash. This would not be practical. With a tube that travels axially and rotates would require 8 nozzles and 16 GPM per cartridge or 400 nozzles and 800 GPM for 50 cartridges.

The backwash tube is in the up position during filtration due to the affixed float and flow of liquid upward to the dome. A pressure switch triggers a backwash by closing the dirty supply and clean discharge valves, and simultaneously a clean system supply valve in the dome and a dirty outlet valve at the bottom open. At this point the dome liquid pressure acts on the backwash tube and downward forces overcome the buoyancy of the floats. Back-washing continues for 1 to 2 minutes requiring a pressure reducing assembly to reduce descending of the tube. An assembly inside the base of the tube contains a cylinder with limited storage of liquid (0.1 gallons) and metering it through a piston rod with multiple orifices to reduce the flow rate, which requires 14 stages of reduction.

### BRIEF DESCRIPTION OF THE DRAWINGS

FIG. 1 illustrates tie entire filter assembly indicating all the filter components;

FIG. 2 illustrates a wire diagram for the automatic electrical and hydraulic components.

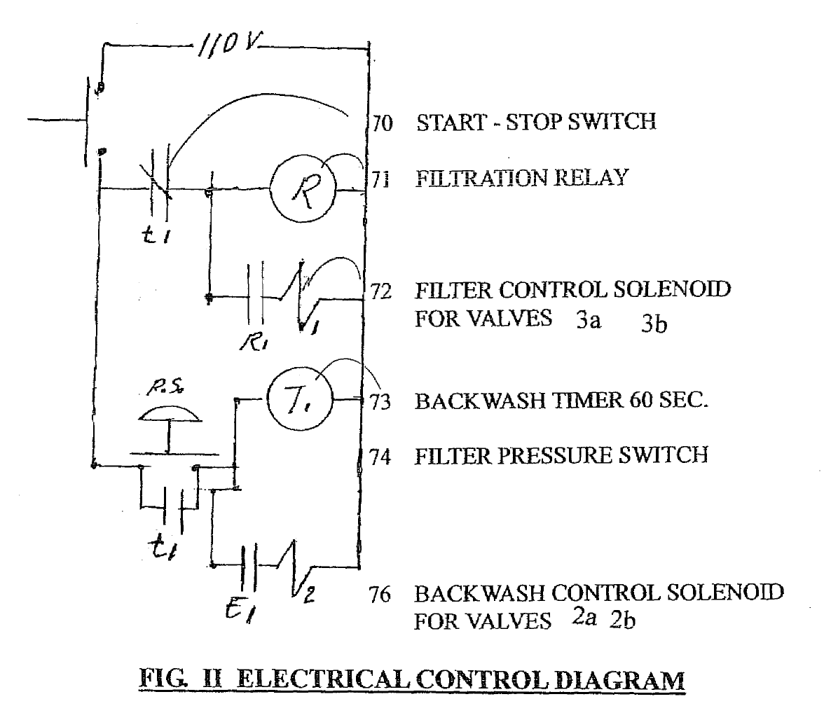

### DETAILED DESCRIPTION OF THE PREFERRED EMBODIMENTS

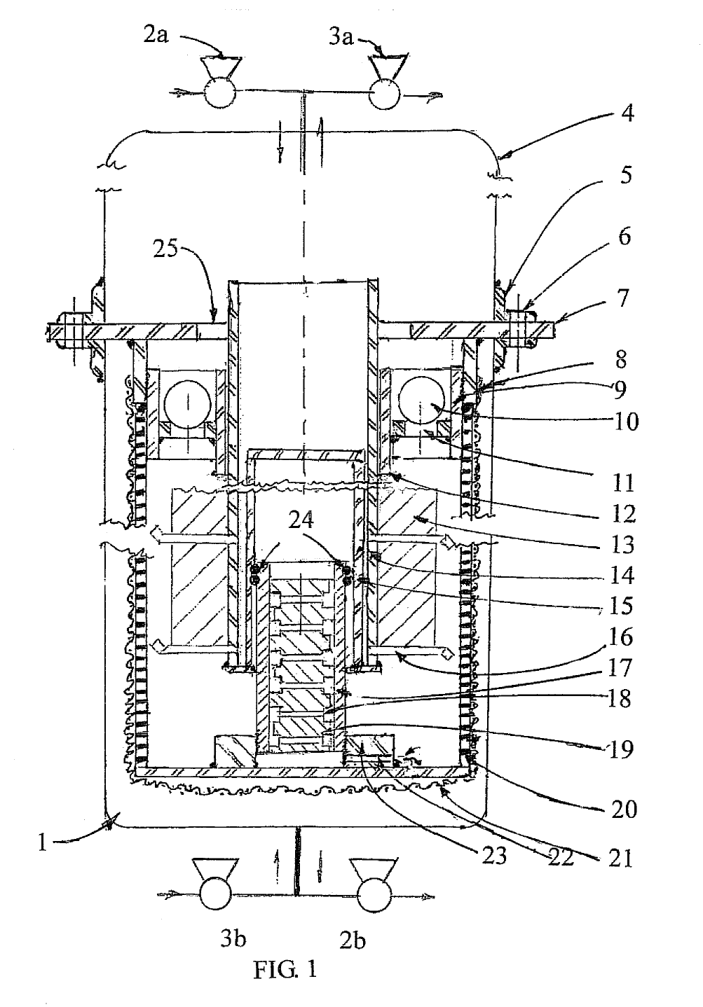

FIG. 1 illustrates a pressure vessel body 1 with a head dome 4 with clean backwash supply valve 2a and dirty backwash discharge valve 2b closed during filtration and open during backwash. Valve 3b is a dirty liquid supply and 3a is clean discharge open during filtration and closed during backwashing. The dome 4 has a flange 5 and bolts 6 to contain a pressure plate 7 with machine flanges on the body 1. A half coupling 8 is affixed to plate 7 and a short pipe 9 is screw attached forming a ball check valve 10 chamber 11 with liquid passage during filtration and closed during backwashing.

A sleeve inside the chamber 12 is provided as a guide for a backwash tube 14 which has clamped on sponge floats 13 extending from lower backwash tubes 16. Inside the base of the backwash tube 14 is a liquid reservoir chamber cylinder 15 with a 0.1 gallon volume having a stationary piston 17 with upper seals 24 and supported and affixed to an anchor block 23 with a liquid out and in passage hole 22.

In use, the central backwash tube 14 with affixed closed cell polymeric floats 13 contain diametrically placed nozzles with end deflectors for rotating the tube 14 during its (typically slow) descent to the bottom during backwashing, and inside of the backwash tube 14 is contained the affixed liquid storage reservoir cylinder 15 with stationary piston rod 17 with multiple orifices in series for reducing a downward travel to one to two minutes. The rod 19 contains a total of fourteen in line ⅛″ diameter orifices 18, and so that the pressure is reduced equally along the fourteen station orifices.

The backwash tube 14 travels vertically upward up to eighteen inches for filtration due to the tube buoyancy and travels downward during backwashing due to a pressurized dome liquid supply overcoming buoyancy forces exerted by the floats 13. The backwash tube 14 is guided in a top cartridge sleeve and at the base from a flow reducing piston rod which is anchored to the base of the stationary cartridge cylinder 20.

Without this arrangement, use of a single orifice would have to be 0.009″ diameter, which would not be practical. The area gained is 0.125²/0.009=fourteen times larger and which has less chance of plugging. The cartridge cylinder 20 positioned in height extending fashion around the chamber 12 backwash tube 14 exhibits 5½″ O.D. and 72″ in length and is made of perforated plate. The cylinder 15 is affixed to a top of a 5″ O.D. pipe and the cylinder is covered with a monofilament polymer mesh 21 secured by clamps not shown. The pressure plate 7 contains a hole 25 sufficient in diameter for the liquid processed.

FIG. II is an electrical control diagram for operational sequencing of the filter. First it is manually started with switch 70, which energizes relay 71, connected to a solenoid contact R1 operating a four way valve 72, opening filter inlet 3b and outlet 3a valves. The unit now is accepting, filtering and discharging filtrate. As pressure builds up due to accumulation of contaminants and the pressure rises to a point where it trips a pressure switch 74, which is wired in series to a timer 73, with instantaneous contact that drops out the filtration control relay 71 for the duration of the wash cycle, and has parallel contact around the pressure switch keeping the wash cycle operating for approximately 60 seconds.

The timer 75, contact t1 closes the backwash valve 76 and backwash valves 2a and 2b open, which generates a liquid force to lower the tube 14, and rotate it for approximately 60 seconds. At approximately 60 seconds timer T1 73 times out and opens its holding contacts t1 and closes the other contact t1 in series with filtration relay 71 resulting in the closure of the backwash valves 2a and 2b and reopening of filtration valves 3b and 3a, at which point normal filtration then resumes. The backwash tube 14 rises slowly by a reverse flow through the valve due to greater upward buoyancy and hydraulic forces.

Having described my invention, other and additional preferred embodiments will become apparent to those skilled in the art to which it pertains and without deviating from the scope of the appended claims.

I claim:

1. An apparatus for automatically filtering liquids, comprising:
a pressure vessel constructed with a clean top dome separated by a pressure plate which is sealed between flanges to close with a lower filter body having a base;
the pressure plate containing liquid passage holes for a cartridge supported on the underside of the plate, an upper end of the cartridge containing a chamber with multiple ball check valves to allow filtered liquid to pass to a dome and to prevent flow during backwashing;
the chamber centrally contains a bushing sleeve for guiding a top portion of a central backwash tube supported within the chamber and which has a closed cell polymeric float affixed to it to create buoyancy, the tube also contains diametrically spaced spray nozzles with end deflectors for rotating the tube during a slow descent during backwashing to a bottom inside of the cartridge;
the backwash tube further including a liquid storage cylinder affixed to the inside base of the tube and the base inside of the tube a rod affixed to a piston and the base of the cartridge is forced downwardly by the pressure of backwash water in the dome and liquid to pass through a series of metering orifices in a rod inside of a piston, the rod is affixed to the bottom of the cartridge, reducing a speed of descent of the tube to 1-2 minutes; and
the backwash tube traveling vertically upward for filtration due to float buoyancy and the cartridge liquid pressure and stays in situ during filtration which starts when dirty supply and clean filter discharge valves are open and backwash supply valve and backwash discharge valve are closed, a rise in pressure through the filter media actuates a pressure switch which closes the filtering valves and opens the backwash supply valve to the dome and the dirty backwash valve to exit the unit.

2. (canceled)

3. The apparatus as described in claim 1, said multiple orifices in series reducing a downward travel of the backwash tube to one to two minutes.

4. The apparatus as described in claim 1, the backwash tube traveling upwardly to a range of up to eighteen inches.

5. The apparatus as described in claim 1, a pressure switch is wired in series to a timer, with instantaneous contact that drops out a filtration control relay for duration of a filtration wash cycle, the timer has parallel contact around the pressure switch keeping the wash cycle operating for a predetermined time interval, following which actuation of electrical contacts result in the closure of the backwash supply and outlet valves and reopening of dirty supply and clean discharge valves.
